(19) United States
(12) Patent Application Publication
(10) Pub. No.: US 2006/0244176 A1
(43) Pub. Date: Nov. 2, 2006

(54) Resin complex and method for producing the same

(75) Inventors: Tomohito Ota, Kanagawa (JP); Masao Saitou, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/405,417

(22) Filed: Apr. 18, 2006

(30) Foreign Application Priority Data
Apr. 27, 2005 (JP) 2005-130420

(51) Int. Cl. B32B 27/34; B32B 27/36; B32B 27/32

(52) U.S. Cl. 264/241; 428/457; 428/339; 428/523; 428/521; 428/480; 428/474.4; 428/473.5

(57) ABSTRACT

The present invention provides a resin complex composed of resin material 10 and other material 20 including metal material or ceramics material, characterized by containing a layer 1 coated with a triazin dithiol derivative and a mixed layer 2 of other material and aluminum, between the resin material 10 and the other material 20. This resin complex exhibits superior junction interface strength, even when ceramics or an iron-based metal is applied as other material.

### BACKGROUND OF THE INVENTION

1. Field of the Invention

The present invention relates to a resin complex made by integration of resin material and a metal or ceramics, along with a production method therefore, and in particular, relates to a resin complex made by integration of resin material and a metal or ceramics, via two layers, along with a production method therefore.

2. Description of the Related Art

In view of weight saving, cost reduction, design freedom improvement and performance improvement, many resin complexes made by integration of resin material and other material, such as a metal or ceramics, have been used as automotive, electric appliances and industrial machinery parts, and the like.

Conventionally, as a method for producing a complex between resin material and other material, a method for using adhesives and an insert molding or outsert molding which injects a molten resin into a mold inserted with other material, and the like have been used. However, a resin complex produced by these methods had a defect of weak junction interface strength, that is, junction strength at the interface of resin material and other material. Furthermore, a resin complex produced by these methods had a defect that junction interface strength became further weaker when subjected to thermal load such as standing still at constant temperature, thermal cycle and heat shock.

To solve the above problems, a complex obtained by junction of a conductive substance treated the surface with a triazin dithiol derivative and a resin, have been disclosed in JP-A-2001-1445 along with a production method therefore. The triazin dithiol derivative has a covalent bond between the conductive substance and the resin, therefore, the conductive substance and the resin have a firm bonding via a triazin dithiol derivative, and the resistance of the complex to thermal load is enhanced.

Chemical structure of a triazin dithiol derivative is shown by the following chemical formula 1. Triazin dithiol enables to bond covalently with resin material by appropriate selection of R in the following chemical formula 1, and bond covalently with a metal by appropriate selection of M¹ and M².

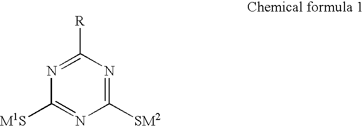

However, a metal having high reactivity with a triazin dithiol derivative is limited to aluminum, bronze, brass and nickel, and thus to obtain a resin complex having practical junction interface strength using a method disclosed in the JP-A-2001-1445, other material is limited to aluminum, bronze, brass and nickel.

To solve this problem, there is a challenge to improve junction interface strength by forming copper plating or nickel plating on the surface of iron-based metal material, as shown in JP-A-5-330712.

### SUMMARY OF THE INVENTION

However, a method disclosed in JP-A-5-330712 may generate crack at the interface between a layer of a triazin dithiol derivative and a plated layer, or has a problem of weak resistance to thermal load at the junction interface between a layer of a triazin dithiol derivative and a plated layer. Namely, conventional technology could not provide a resin complex having practical junction interface strength, using ceramics or an iron-based metal widely used as structural material, as other material.

To solve the problems, an object of the present invention is to provide a resin complex having superior junction interface strength, even when ceramics or an iron-based metal is applied as other material.

In addition, an object of the present invention is to provide a method for producing the resin complex.

The present inventors have noticed the fact that reactivity between a triazin dithiol derivative and aluminum is very superior, and a plated layer generates concentrated stress under load, and by combined use of a layer of a triazin dithiol derivative and a mixed layer composed of other material and aluminum, the problems can be solved, and thus completed the present invention.

That is, the present invention solves the problems by a resin complex composed of resin material and other material comprising metal material or ceramics material, comprising a layer of a triazin dithiol derivative, and a mixed layer of other material and aluminum, between the resin material and the other material.

### BRIEF DESCRIPTION OF THE DRAWINGS

FIG. 1 is a brief cross-sectional view showing an example of a resin complex of the present invention.

FIG. 2 is a brief plain view and a brief cross-sectional view of resin complexes of Examples 1 to 3, Comparative Examples 1 to 3.

### DESCRIPTION OF THE PREFERRED EMBODIMENTS

In the first aspect of the present invention, a resin complex composed of resin material and other material comprising metal material or ceramics material, comprising a layer of a triazin dithiol derivative, and a mixed layer of other material and aluminum, between the resin material and the other material is provided.

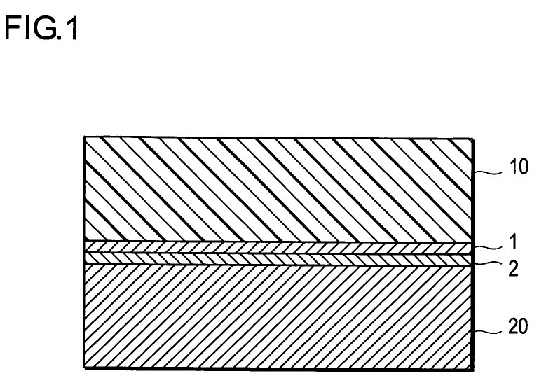

Cross-sectional view of the resin complex is shown in FIG. 1. In FIG. 1, by having a mixed layer 2 of other material and aluminum, and a layer 1 coated with a triazin dithiol derivative at the surface of other material 20, and by junction of the layer 1 coated with the triazin dithiol derivative and resin material 10, a resin complex having superior junction interface strength can be obtained, even when various materials such as ceramics or an iron-based metal are applied as other material 20. However, the present invention is by no means limited to FIG. 1, and shape of resin material, shape of other material, forming position of a mixed layer and lamination position of a layer of a triazin dithiol derivative can be determined, as appropriate, depending on objectives.

Other material is not especially limited, and various metal materials and various ceramics materials can be used, as appropriate.

As metal material, an iron-based metal, copper, nickel, gold, silver, platinum, palladium, cobalt, zinc, lead, tin, titanium, chromium, magnesium, manganese and an alloy thereof are preferable and an iron-based metal is more preferable. As an iron-based metal, pure iron; plain steel such as SS, SC, SPC and SPCC; special steel such as SUS, SMn, SCr, SCM, SNCM, SWRH, SUH, SK, SKH, SKS, SKD, SKC, SUP, SWRS and SUJ, and the like are preferably included. In this connection, abbreviated symbols such as SS are in accordance with JIS symbols. In spite of an iron-based metal being versatile material superior in mechanical strength, and the like, a resin complex having practical junction interface strength was difficult to obtain using an iron-based metal by conventional technology, as described above, and thus the significance to select an iron-based metal as other material is large.

As ceramics material, oxide-based ceramics such as alumina, zirconia, magnesia, beryllia, thoria, urania, silica, titania, barium titanate and strontium titanate; or nonoxide-based ceramics such as silicon nitride, silicon carbide, boron nitride, zirconium carbide and diamond, and the like are included.

A mixed layer is one obtained by mixing aluminum and other material. As other material contained in a mixed layer, it is preferable to use the same material as other material which makes complex with resin material in a resin complex.

It is preferable that a layer composed of only aluminum is not present in the mixed layer. This is because, when a resin complex containing a layer composed of only aluminum is subjected to load, stress is concentrated to a layer composed of only aluminum, which increases in-layer-fracture in a layer composed of only aluminum, and thus may break a resin complex at the boundary of a layer composed of only aluminum.

Aluminum concentration in a mixed layer can be determined, as appropriate, depending on adhesiveness of a layer of a triazin dithiol derivative, mechanical strength of a mixed layer or kind of other material used.

A mixed layer is preferably a compound layer composed of other material and aluminum. The compound layer is preferably an intermetallic compound. An intermetallic compound is superior in mechanical strength compared with solid solution.

Thickness of the mixed layer is not especially limited, preferably 1 to 100 μm, more preferably 10 to 50 μm and further preferably 20 to 40 μm. The thickness below 1 μm may bring about difficulty forming in view of fabrication method, while the thickness over 100 μm may bring about easy occurrence of brittle failure. The brittle failure may occur especially in the case when a mixed layer is a hard coated film.

Average surface roughness (Ra) of a mixed layer is preferably not higher than 1.0 μm. The average surface roughness over 1.0 μm may lower junction interface strength between resin material and other material.

In a resin complex, resin material and other material bond firmly via a layer of a triazin dithiol derivative and a mixed layer, because a triazin dithiol derivative is covalently bonded with resin material and a mixed layer. This results in improvement of resistance to thermal load of the junction interface between resin material and other material. Detailed explanation of a layer of a triazin dithiol derivative is described later in the item of a production method.

In the case when other material is an iron-based metal, formation of a mixed layer on the surface of other material makes hardness of the mixed layer as high as a Vickers hardness of about 700 to 1000, and the mixed layer fulfils roles not only as an intermediate layer for junction but also as a protecting layer for an iron-based metal.

Resin material is not especially limited, and can be selected, as appropriate, depending on objectives, and resin material with high reactivity with a triazin dithiol derivative is preferable. As resin material with high reactivity with a triazin dithiol derivative, at least one kind selected from the group consisting of polyethylene, polypropylene, acrylonitrile-butadiene-styrene resin, polyamide, polyethylene terephthalate, polybutylene terephthalate, polyphenylene sulfide, liquid crystal resin, polyether ether ketone, polyether ketone and polyamide imide, or a copolymer containing monomers of these resins is preferably included, and more preferable resin material is a polyamide resin or a polyphenylene sulfide resin. A polyamide resin and a polyphenylene sulfide resin are particularly superior in reactivity with a triazin dithiol derivative, and moreover superior in mechanical strength or heat resistance as a resin itself.

Additives may be added to resin material, in accordance with on objectives. As additives, fiber-reinforced material such as carbon fiber, glass filler and ultra high-strength polyethylene fiber, UV stabilizer, light stabilizer, metallic whisker, calcium carbonate and talc, and the like are preferably included.

As for a combination of resin material and other material, it is preferable that resin material is a polyamide resin or a polyphenylene sulfide resin, and a metal is steel. A resin complex with these combinations is superior in mechanical strength or heat resistance.

In the second aspect of the present invention, a method for producing a resin complex, comprising: (I) forming a mixed layer of other material and aluminum on the surface of other material, (II) forming a film of a layer coated with triazin dithiol derivative on the mixed layer, and (III) uniting the layer of a triazin dithiol derivative and resin material is provided.

As for resin material, other material, and a mixed layer of other material and aluminum, they are as described above.

As the process (I), a metal diffusion method such as an infiltration method and a calorizing method, an ion injection method and a sputtering method are preferably included, and a metal diffusion method is more preferable, and an infiltration method is particularly preferable. By application of the metal diffusion method, a compound layer of other material and aluminum can be formed. By application of the infiltration method, an intermetallic compound can be formed, when other material is a metal. As described above, an intermetallic compound is superior in mechanical strength compared with solid solution.

The infiltration method is a method to immerse other material into molten aluminum and to diffuse and infiltrate the aluminum from the surface of other material, and a molten aluminum temperature of 660 to 750° C. is preferable. The temperature below 660° C. may bring about insufficient fusion of aluminum in a bath, while the temperature over 750° C. may bring about excessive promotion of aluminum diffusion and a layer composed of only aluminum may be formed. Time to immerse other material into aluminum can be determined, as appropriate, depending on other material used or molten aluminum temperature. When molten aluminum temperature is within the above range, 3 to 7 minutes of immersion, subsequent lifting once from the bath and re-immersion for 3 to 7 minutes are preferable. By carrying out immersion twice separately in the above immersion time, thickness of a mixed layer can be made to desirable range. Preferable thickness of a mixed layer is as described above.

As post-treatment of the process (I), acid washing using a dilute hydrochloric acid, and the like may be adopted. By carrying out acid washing, flux adhered at the surface can be removed.

The process (II) is not especially limited, and film formation is preferably carried out by an electrochemical method, comprising immersing the other material formed with the mixed layer, in an electrolytic solution including a multifunctional triazin dithiol derivative represented by chemical formula 1: 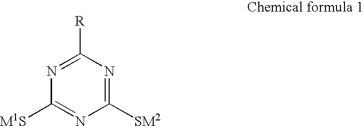
wherein, R represents —OR¹, —OOR¹, —SaR¹, —N(R¹)R², —OR³R¹, —OOR³R¹, —SaR³R¹ or N(R¹)R³R²; R¹ and R² maybe the same or different and represent H, Na, hydroxyl group, carbonyl group, ether group, ester group, amide group, amino group, phenyl group, cycloalkyl group, alkyl group, alkynyl group and alkenyl group; R³ represents a carbonyl bond, an ether bond, an ester bond and an amide bond; a represents an integer of 1 to 8; and M¹ and M² may be the same or different and represent H, Li, Na, K, Ba, Ca, or ammonium salt.

A multifunctional triazin dithiol derivative represented by chemical formula 1 enables to simply and conveniently form a layer of a triazin dithiol derivative on a mixed layer, by using an electrochemical method.

A specific example of the process (II) is shown below, however, the present invention is by no means limited thereto. Into a mixed solution of a triazin dithiol derivative and a solvent, other material formed with a mixed layer at the surface, and a cathode are immersed. Subsequently, using the other material as an anode, and by passing an electric current between the cathode and the anode, a layer of a triazin dithiol derivative is formed at the surface of a mixed layer.

As the solvent, water; alcohols such as methanol or ethanol; carbitol; glycol ethers such as cellosolve; dimethylformamide; methylpyrrolidone; acrylonitrile; and ethylene carbonate, and the like are included. The solvent may contain supporting electrolytes, and as supporting electrolytes, sodium nitrite, potassium nitrate, sodium sulfate, potassium sulfate, sodium perchlorate, potassium chloride, sodium chloride, lithium chloride, and the like are included. As the cathode, a platinum plate, a titanium plate, a carbon plate, an aluminum plate, a stainless plate, and the like are included. A voltage of 1 to 3 V is preferable and an energization time of 3 to 10 minutes is preferable.

As pre-treatment of the process (II), other material formed with a mixed layer at the surface may be subjected to alkali treatment or acid treatment, and washing with pure water. As described above, the average surface roughness of other material over 1.0 μm may lower adhesion between other material and a mixed layer, and this poor adhesion between other material and a mixed layer may bring about partial peeling of a mixed layer in the pre-treatment process.

In the process (III), resin material and other material are preferably integrated in one piece in a molding die, and insert molding or outsert molding is more preferable. By applying insert molding or outsert molding, a resin complex can be produced at a low cost.

Insert molding or outsert molding enables to promote a reaction between resin material and a layer of a triazin dithiol derivative, by effective utilization of heat and pressure on injection of resin material into a mold.

In the third aspect of the present invention, automotive parts comprising the resin complex, or a resin complex produced by a method for producing the resin complex are provided.

Since automotive parts are often subjected to thermal load such as standing still at constant temperature, thermal cycle and heat shock, component material of a resin complex is limited, when a resin complex is applied to automotive parts, and application of ceramics or an iron-based metal as other material was difficult. This is because junction interface strength was weak to thermal load, in the case when ceramics or an iron-based metal is used as other material in a conventional resin complex.

However, a resin complex of the present invention has high resistance to thermal load and seldom lowers junction interface strength, even if ceramics or an iron-based metal is applied as other material. Therefore, a resin complex of the present invention can preferably be applied to automotive parts which are exposed to thermally harsh environment.

In the fourth aspect of the present invention, slide member comprising the resin complex, or a resin complex produced by a method for producing the resin complex is provided.

Since slide members, among various parts, are often subjected to mechanical load, component material of a resin complex is limited, when a resin complex is applied to slide members, and application of ceramics or an iron-based metal as other material was difficult. This is because junction strength with resin material was low and stress was concentrated to a junction part, in the case when ceramics or an iron-based metal is used as other material in a conventional resin complex.

However, a resin complex of the present invention provides high junction strength between resin material and other material, and high resistance to mechanical load, even if ceramics or an iron-based metal is applied as other material. Therefore, a resin complex of the present invention can preferably be applied to slide members.

### EXAMPLES

The present invention is explained specifically using Examples, however, these Examples should by no means limit the present invention.

### Example 1

As pre-treatment of a plate-like test piece of SPCC having an average surface roughness Ra=0.1 μm, a length of 49 mm, a width of 11.5 mm and a thickness of 1.2 mm, the test piece was immersed in an aqueous solution of sodium hydroxide at 60° C. for 15 minutes, and subjected to alkali degreasing, washing with water, acid washing with 12% dilute hydrochloric acid, washing with water, washing with hot water and then drying by air blowing.

Then, the plate-like test piece of SPCC was immersed in molten aluminum at 690° C. for 5 minutes, subsequently lifted up once from molten aluminum and then immersed again in molten aluminum for 5 minutes. Then it was subjected to acid washing with 12% dilute hydrochloric acid and washing with water. Using SEM, thickness of a mixed layer of SPCC and aluminum, formed at the surface of the plate-like test piece of SPCC, was measured and found to be 30 μm.

As pre-treatment to form a layer of a triazin dithiol derivative, the plate-like test piece of SPCC, formed with a mixed layer of SPCC and aluminum, was subjected to alkali etching, washing with water, acid washing, washing with water and vacuum drying. Then an aqueous solution of 1,3,5-triazine-2,4-dithiol-6-sodium thiolate (hereinafter referred to as TTN: Trade name of Zisnet N1 from Sankyo Kasei Co., Ltd.) with a concentration of 5 mmol/L, was prepared and the TTN aqueous solution of 5 mmol/L was poured into an immersing tank, and sodium nitrite was added so as to become 0.5% by mass as a supporting electrolyte.

Subsequently, the plate-like test piece of SPCC, a platinum plate and a saturated calomel electrode were set in the immersing tank, a voltage of 2 V for 5 minutes to the anode-cathode was loaded, using the plate-like test piece of SPCC as an anode, the platinum plate as a cathode and the saturated calomel electrode as a reference electrode. Then, the test piece was washed with distilled water, washed with methanol and dried with warm air of 60° C. Using SEM, thickness of a layer coated with TTN film, formed on the mixed layer of SPCC and aluminum, was measured and found to be 50 nm.

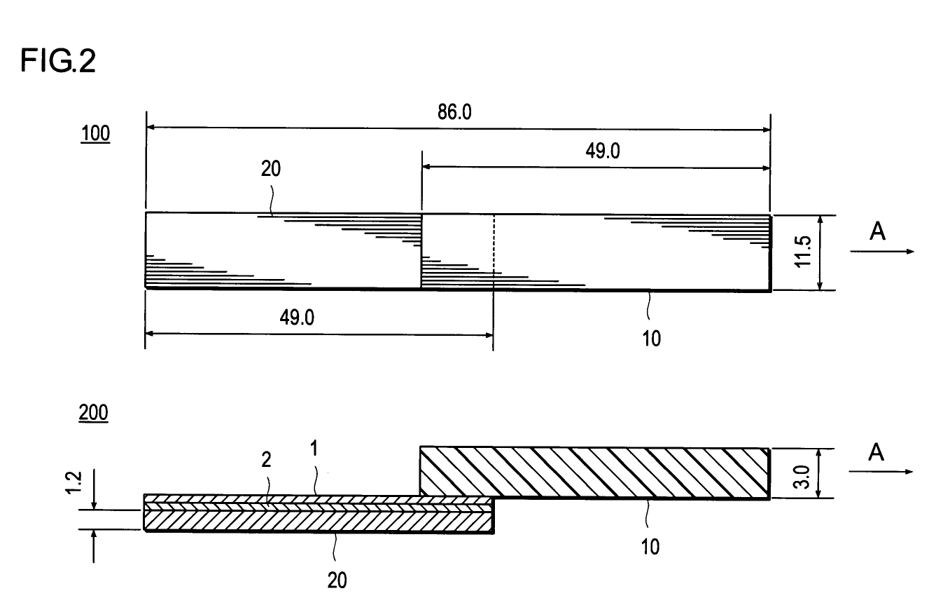

The plate-like test piece of SPCC was put in a mold, and a outsert molding was carried out by casting a molten polyphenylene sulfide (PPS from Tosoh Corp., Trade name of Susteel CH-30) containing 30% by mass of carbon fiber, and a resin complex was obtained. Shape of a resin complex obtained is shown in FIG. 2. In FIG. 2, code 1 represents a layer of a triazin dithiol derivative, code 2 represents a mixed layer of other material and aluminum, code 10 represents resin material, code 20 represents other material, code 100 represents a brief plain view showing a resin complex and code 200 represents a brief cross-sectional view showing a resin complex.

### Example 2

A resin complex was obtained similarly as in Example 1, except that polyether ether ketone (PEEK) containing 30% by mass of carbon fiber was used as resin material.

### Example 3

A resin complex was obtained similarly as in Example 1, except that SPCC with an average surface roughness Ra=2.0 μm was used as resin material.

### Example 4

A resin complex was obtained similarly as in Example 1, except that molding was carried out at a molten aluminum temperature of 830° C. so that a mixed layer of SPCC and aluminum contained a layer composed of only aluminum. Using SEM, thickness of a mixed layer of SPCC and aluminum, containing a layer composed of only aluminum, formed on the surface of the plate-like test piece of SPCC, was measured and found to be 10 μm.

### Comparative Example 1

A resin complex was obtained similarly as in Example 1, except that a nickel plated layer was formed instead of a mixed layer of other material and aluminum.

The nickel plated layer was obtained by using an aqueous solution added with 400 g/L of nickel sulfate, 65 g/L of nickel chloride and 40 g/L of boric acid, as a plating solution, and by immersing the plate-like test piece of SPCC in the plating solution kept at 60° C., followed by nickel plating under an anode current density of 5 A/dm². Using SEM, thickness of the nickel plated layer, formed on the surface of the plate-like test piece of SPCC, was measured and found to be 10 μm.

### Comparative Example 2

A resin complex was obtained similarly as in Example 1, except that a copper plated layer was formed instead of a mixed layer of other material and aluminum.

The copper plated layer was obtained by using an aqueous solution added with 80 g/L of copper pyrophosphate, 30 g/L of metal copper, 310 g/L of potassium pyrophosphate and 1 ml/L of ammonia, as a plating solution, and by immersing the plate-like test piece of SPCC in the plating solution kept at 50° C., followed by copper plating under an anode current density of 2 A/dm². Using SEM, thickness of the copper plated layer, formed on the surface of the plate-like test piece of SPCC, was measured and found to be 10 μm.

### Comparative Example 3

As pre-treatment of the plate-like test piece of SPCC, having an average surface roughness Ra=0.1 μm, a length of 49 mm, a width of 11.5 mm and a thickness of 1.2 mm, the test piece was immersed in an aqueous solution of sodium hydroxide at 60° C. for 15 minutes and subjected to alkali degreasing. Then, the surface of a plate-like test piece made of PPS (from Tosoh Corp.; Trade name of Susteel CH-30), containing 30% by mass of carbon fiber, having a length of 49 mm, a width of 11.5 mm and a thickness of 3 mm, was washed with hexane and degreased.

The plate-like test piece of SPCC and the plate-like test piece of PPS, containing 30% by mass of carbon fiber, were adhered with epoxy resin-based adhesives (from Sumitomo 3M Co., Ltd.: Trade name of DP-420) to obtain a resin complex shown in FIG. 2.

### Comparative Example 4

It was attempted to obtain a resin complex similarly as in Example 1, except that a mixed layer of SPCC and aluminum was not formed. However, peeling was generated between SPPC and the PPS resin, on ejection of an outsert molded substance from a mold.

By investigation of the causes, it is contemplated that SPCC corroded in an electrolytic plating solution, during the formation process of a film coated with the above TTN, and any bonding between SPCC and TTN was not formed, and formation of a film coated with TTN did not advance.

### Confirmation of Junction Interface Strength

To confirm the junction interface strength of resin complexes of Examples 1 to 4 and Comparative Examples 1 to 3, a shear test of resin complexes was carried out before and after a thermal cycling test.

The thermal cycling test was carried out by holding a resin complex at −40° C. for 3 hours, heating up to 150° C. over 1.5 hours, holding at 150° C. for 3 hours and cooling down to −40° C. over 1.5 hours, and by making this cycle as one cycle (time required 9 hours), the test was repeated 200 cycles.

The shear test was carried out by using a universal tensile testing machine and setting a test temperature at room temperature and a rate of elongation at 50 mm/min, and by fixing the other material and pulling a resin complex to the direction of code A in FIG. 2. As the results of these tests, a fracture stress that is a stress at fracture of a resin complex in the shear test carried out before and after thermal cycle test (TCT), and a difference in fracture strength before and after TCT, are shown in Table 1.

TABLE 1

| | | TTN layer/ | | | Before TCT | After TCT | Fracture stress |
|---|---|---|---|---|---|---|---|
| | | Adhesives | Mixed layer/ | Other | Fracture stress | Fracture stress | difference |
| | Resin | Thickness | Plated layer | material | (MPa) | (MPa) | (MPa) before |
| | material | (nm) | Thickness (μm) | Ra (μm) | Fracture position | Fracture position | and after TCT |
| Example 1 | PPS | TTN | SPCC-Al Mixed layer | SPCC | 12.2 | 11.8 | 0.4 |
| | *1 | 50 | 30 | 0.1 | Resin material | Resin material | |
| Example 2 | PEEK | TTN | SPCC-Al Mixed layer | SPCC | 6.8 | 6.5 | 0.3 |
| | *1 | 50 | 30 | 0.1 | *2 | *2 | |
| Example 3 | PPS | TTN | SPCC-Al Mixed layer | SPCC | 9.7 | 9.5 | 0.2 |
| | *1 | 50 | 30 | 2 | Mixed layer | Mixed layer | |
| Example 4 | PPS | TTN | SPCC-Al Mixed layer + | SPCC | 7.4 | 6.2 | 1.2 |
| | *1 | 50 | *3 | 0.1 | *3 | *3 | |
| | | | 30 | | | | |
| Comp. | PPS | TTN | Ni plated layer | SPCC | 5.4 | 3.4 | 2.0 |
| Exam. 1 | *1 | 50 | 10 | 0.1 | *4 | *2 | |
| Comp. | PPS | TTN | Cu plated layer | SPCC | 10.7 | 8.2 | 2.5 |
| Exam. 2 | *1 | 50 | 10 | 0.1 | *5 | *5 | |
| Comp. | PPS | Adhesives | — | SPCC | 6.8 | 1.8 | 5.0 |
| Exam. 3 | *1 | | | 0.1 | Adhesives | Adhesives | |

(Note)
*1: containing 30% by mass of carbon fiber
*2: interface between a layer of TTN and resin material
*3: a layer composed of only aluminum
*4: interface between a layer coated with TTN and a nickel plated layer
*5: interface between a layer coated with TTN and a copper plated layer

As is shown by Table 1, resin complexes of Examples 1 to 4 can be judged to provide high resistance to thermal load of junction interface between resin material and other material, because of having smaller decrease in fracture stress before and after the thermal cycle test (TCT) compared with those in Comparative Examples 1 to 3.

Among resin complexes of Examples 1 to 4, fracture stress of a resin complex of Example 1 is the highest and the occurrence position of fracture is not at the junction interface but resin material itself. Reasons are considered as follows: In comparison between Examples 1 and 2, PEEK has higher reactivity with a layer of TTN than PPS. In comparison between Examples 1 and 3, smaller average surface roughness of other material provides higher adhesion between other material and a mixed layer of other material and aluminum. In comparison between Examples 1 and 4, when a resin complex contains a layer composed of only aluminum, stress is concentrated at the layer composed of only aluminum and inner-layer-fracture is progressed in the layer composed of only aluminum.

The entire disclosure of Japanese Patent Application No. 2005-130420 filed on Apr. 27, 2005 including specification, claims, drawing and summary are incorporated herein by reference in its entirety.

1. A resin complex, composed of resin material and other material comprising metal material, comprising a mixed layer of other material and aluminum, and a layer of a triazin dithiol derivative between the resin material and the other material.

2. A resin complex according to claim 1, wherein a layer composed of only aluminum is not present in the mixed layer.

3. A resin complex according to claim 1, wherein the mixed layer is a compound layer composed of the other material and the aluminum.

4. A resin complex according to claim 1, wherein thickness of the mixed layer is 1 to 100 μm.

5. A resin complex according to claim 1, wherein the resin material is at least one kind selected from the group consisting of polyethylene, polypropylene, acrylonitrile-butadiene-styrene, polyamide, polyethylene terephthalate, polybutylene terephthalate, polyphenylene sulfide, liquid crystal resin, polyether ether ketone, polyether ketone and polyamide imide.

6. A resin complex according to claim 1, wherein the resin material is a polyamide resin or a polyphenylene sulfide resin, and the other material is steel.

7. A method for producing a resin complex, comprising: (I) forming a mixed layer of other material and aluminum on the surface of other material comprising metal material, (II) forming a film of a layer of a triazin dithiol derivative on the mixed layer, and (III) uniting the layer of a triazin dithiol derivative and resin material.

8. A method for producing a resin complex according to claim 7, wherein the process (I) is carried out by immersing the other material in molten aluminum at a temperature of 660 to 750° C.

9. A method for producing a resin complex according to claim 7, wherein in the process (II), a film of a layer of a triazin dithiol derivative is formed by electrochemical method, comprising immersing the other material formed with the mixed layer, in an electrolytic solution including a multifunctional triazin dithiol derivative represented by chemical formula 1: 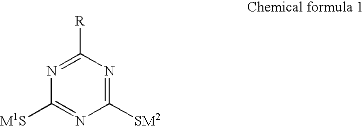
wherein R represents —OR¹, —OOR¹, —SaR¹, —N(R¹)R², —OR³R¹, —OOR³R¹, —SaR³R¹ or N(R¹)R³R²; R¹ and R² may be the same or different and represent H, Na, hydroxyl group, carbonyl group, ether group, ester group, amide group, amino group, phenyl group, cycloalkyl group, alkyl group, alkynyl group and alkenyl group; R³ represents a carbonyl bond, an ether bond, an ester bond and an amide bond; a represents an integer of 1 to 8; and M¹ and M² may be the same or different and represent H, Li, Na, K, Ba, Ca, or ammonium salt.

10. A method for producing a resin complex according to claim 7, wherein the process (III) is insert molding or outsert molding.

11. An automotive part, comprising a resin complex set forth in claim 1.

12. An automotive part, comprising a resin complex produced by a method for producing set forth in claim 7.

13. A slide member, comprising a resin complex set forth in claim 1.

14. A slide member, comprising a resin complex produced by a method for producing set forth in claim 7.
